(19) United States
(12) Patent Application Publication
(10) Pub. No.: US 2012/0179741 A1
(43) Pub. Date: Jul. 12, 2012

(54) METHOD OF RUNNING A SUBSTATION OF AN ELECTRIC POWER SUPPLY SYSTEM

(75) Inventors: Christoph Gerdes, Muenchen (DE); Clemens Hoga, Nuernberg (DE)

(73) Assignee: SIEMENS AKTIENGESELLSCHAFT, MUENCHEN (DE)

(21) Appl. No.: 13/496,643

(22) PCT Filed: Sep. 16, 2009
(86) PCT No.: PCT/EP09/06691

§ 371 Date: Mar. 16, 2012

(51) Int. Cl. G06F 15/16

(52) U.S. Cl. 709/201

(57) ABSTRACT

A substation device for a substation of an electric power supply system is configured to use device-dependent physical addresses for communication with other substation devices of the substation. The substation device has a processing module for processing the data content of messages. In one embodiment of the invention, the substation device further has an address translating module for translating the device-dependent physical addresses into device-independent virtual addresses and vice versa. The processing module is preferably connected to the address translating module and configured to process messages based on the virtual addresses.

The invention relates to substation devices for substations of electric power supply systems. Such substation devices may comprise protection and/or control equipment for measuring, switching, protecting and/or controlling electrical components or branches of the electric power supply system.

Prior art substation devices comprise processing modules for processing data content of messages, and are configured to use device-specific physical addresses for communication with other substation devices.

Prior art substation devices require costly and error prone engineering processes. Each substation device needs to be configured separately using vendor supplied tools. Included in the parameter set of each device are device-specific physical addresses such as MAC addresses (MAC: Media-Access-Control-addresses) of other substation devices. These addresses are used for communication such as for sending GOOSE messages according to IEC61850 standard (GOOSE: General Object Oriented System Environment).

Since physical addresses are device specific and often not alterable, replacement of a single substation device requires also reconfiguration of all other substation devices connected to the one being replaced. For instance, if a substation device needs to be replaced, other substation devices that were configured to send messages to the old MAC address of the replaced substation device need to be identified and reconfigured.

The object of the present invention is to provide a substation device which requires less reconfiguration effort in case of a device replacement.

According to the invention, this object is achieved by a substation device comprising the features of claim 1.

According to the invention the substation device comprises an address translating module for translating device-dependent physical addresses into device-independent virtual addresses and vice versa.

The essential advantage of the present invention consists of the decoupling of external communication from internal data content processing. The data content processing can be carried out based on virtual addresses, only. As such, if an old substation device is replaced by a new substation device, the processing modules of the remaining substation devices need not be updated as they can continue their processing algorithms based on the old virtual addresses. Only the address translating module needs to be modified by updating the assignment between the virtual address, which remains unchanged, and the new physical address. This update, however, can easily be carried out. For instance, if the translating module uses a routing table comprising virtual and physical address pairs, each of which correlating a physical address and a corresponding virtual address, the update merely requires an exchange of a single address pair. Obviously, the remaining routing table may stay unchanged. In other words, an update just requires the exchange of a single physical address with a single entry in a routing table. Preferably each substation device updates itself after receiving an update message comprising a new address pair for its routing table.

Preferably, the address translating module is configured to modify incoming messages, which are no update messages, by replacing all physical addresses comprised therein with the corresponding virtual addresses. The address translating module preferably forwards the modified messages to the processing module.

Furthermore, the address translating module preferably modifies outgoing messages, which are provided by the processing module and which are no update messages, by replacing all virtual addresses comprised therein with corresponding physical addresses. Then, the address translating module may transmit the modified messages to the recipient(s).

According to a further preferred embodiment, the address translating module has access to a routing table which comprises virtual and physical address pairs. Each address pair correlates a physical address and a corresponding virtual address.

The routing table may be stored in a central memory located in one of the substation devices. In this case, all other substation devices should also have access to the central memory.

Alternatively, each substation device comprises its own memory for storing the routing table.

In the latter case, the translating module is preferably configured to update its routing table upon receiving an update message comprising an address pair having the physical address of a new device and the virtual address of an old device, which has been replaced by the new device. Such an update message is preferably generated by the new device after initialization.

The physical addresses are preferably Media-Access-Control-addresses. A MAC address is a unique identifier assigned to most network adapters or network interface cards by the manufacturer, and used in the Media Access Control protocol sublayer. MAC addresses are also known as Ethernet Hardware addresses (EHA), hardware addresses, or adapter addresses.

The invention also relates to a substation of an electric power supply system. According to a preferred embodiment, each of the substation devices comprises a device-dependent physical address for communication over a communication network. Further, each of the substation devices is assigned a device-independent virtual address in addition to the device-dependent physical address. An address translating module in each of the substation devices translates physical addresses into virtual addresses and vice versa. A processing module in each of the substation devices internally processes the contents of messages based on the virtual addresses. The substation devices are connected with each other via the communication network which forwards messages based on the physical addresses.

The invention further relates to a method of running a substation of a power supply system. Preferably substation devices exchange messages via a communication network, wherein the messages indicate the physical address of the respective sender and/or the physical address of the respective recipient(s). Upon receiving a message each substation device replaces physical addresses contained in the message with corresponding virtual addresses, and internally processes the message based on the virtual addresses.

The substation devices may also process outgoing messages based on virtual addresses, only, and replace all virtual addresses with corresponding physical addresses before transmitting the messages via the communication network.

The substation devices may use a routing table comprising pairs of physical addresses and corresponding virtual addresses, and may replace physical addresses with corresponding virtual addresses and vice versa virtual addresses with corresponding physical addresses referring to entries in the routing table.

Upon replacing an old substation device with a new substation device, the new device preferably publishes an address pair comprising its physical address and the virtual address of the old device. The other substation devices will receive this new address pair and can automatically update their routing table in order to send and receive further messages based on the new address pair.

In order that the manner in which the above-recited and other advantages of the invention are obtained will be readily understood, a more particular description of the invention briefly described above will be rendered by reference to specific embodiments thereof which are illustrated in the appended drawings. Understanding that these drawings depict only typical embodiments of the invention and are therefore not to be considered to be limiting of its scope, the invention will be described and explained with additional specificity and detail by the use of the accompanying drawings in which

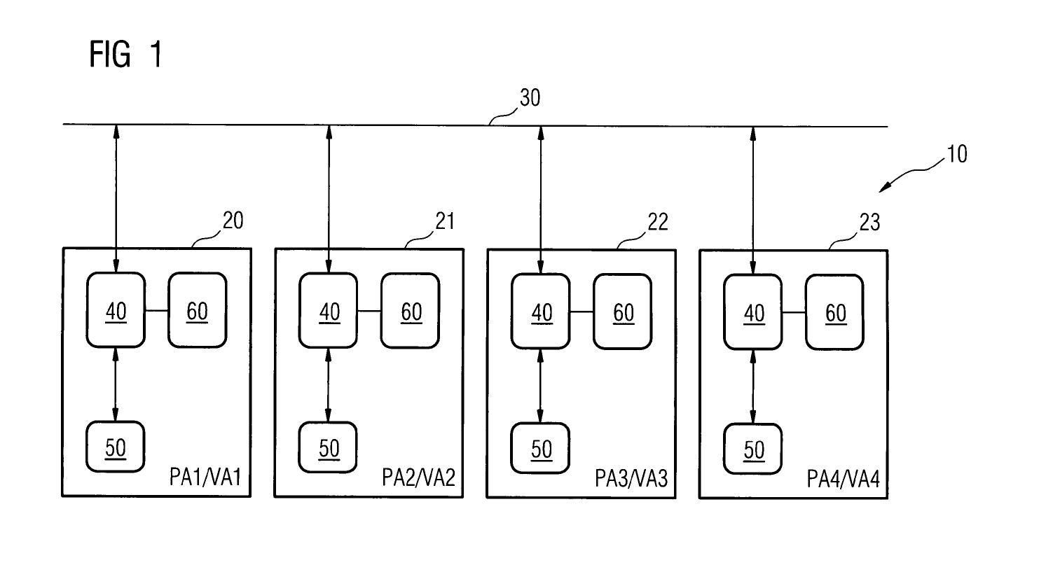

FIG. 1 shows an exemplary embodiment of an inventive substation;

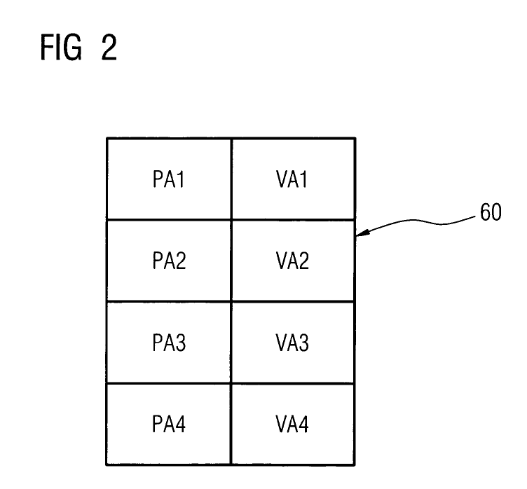

FIG. 2 shows an exemplary embodiment of a routing table for the substation shown in FIG. 1;

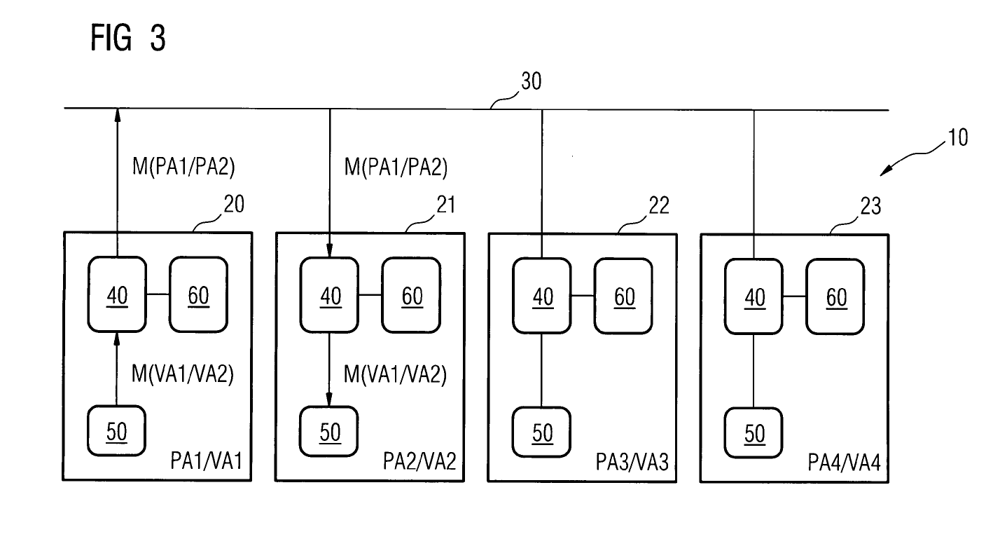

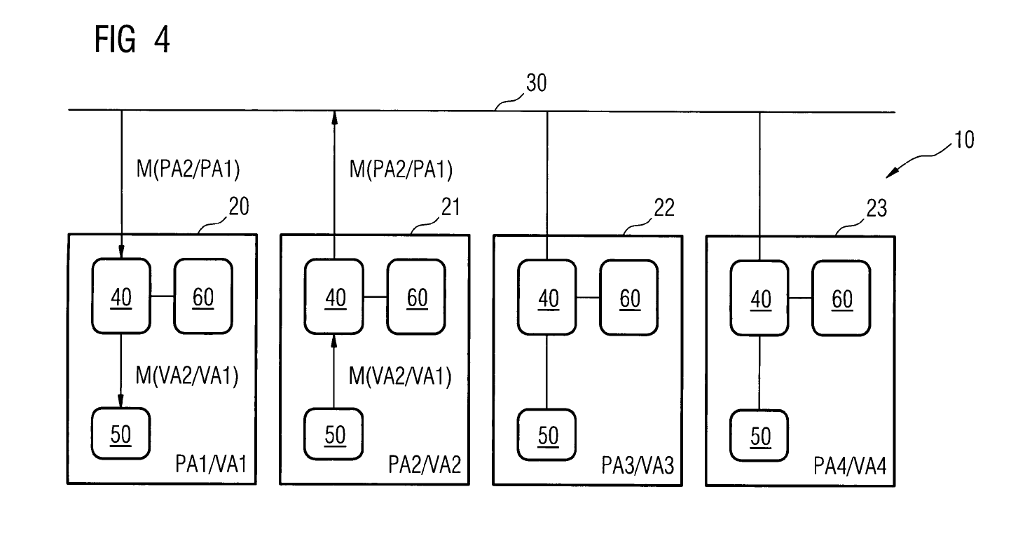

FIGS. 3 and 4 show in exemplary fashion a transmission of messages between substation devices of the substation shown in FIG. 1;

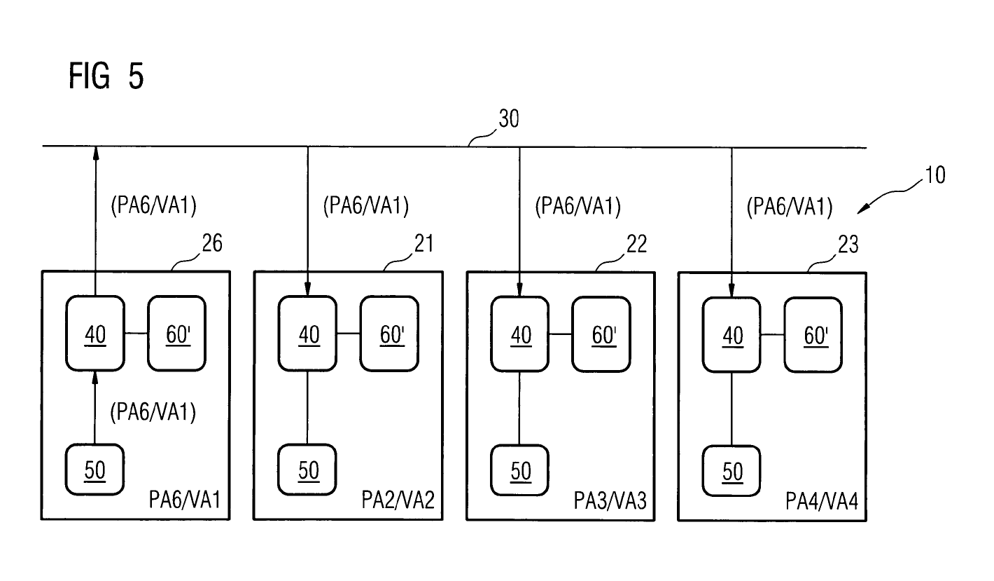

FIG. 5 shows in exemplary fashion the replacement of a substation device of the substation shown in FIG. 1 and the subsequent automatic reconfiguration;

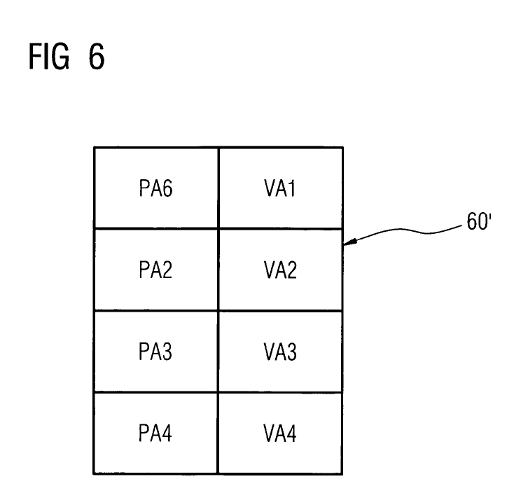

FIG. 6 shows an exemplary embodiment of an updated routing table for the substation shown in FIG. 1; and

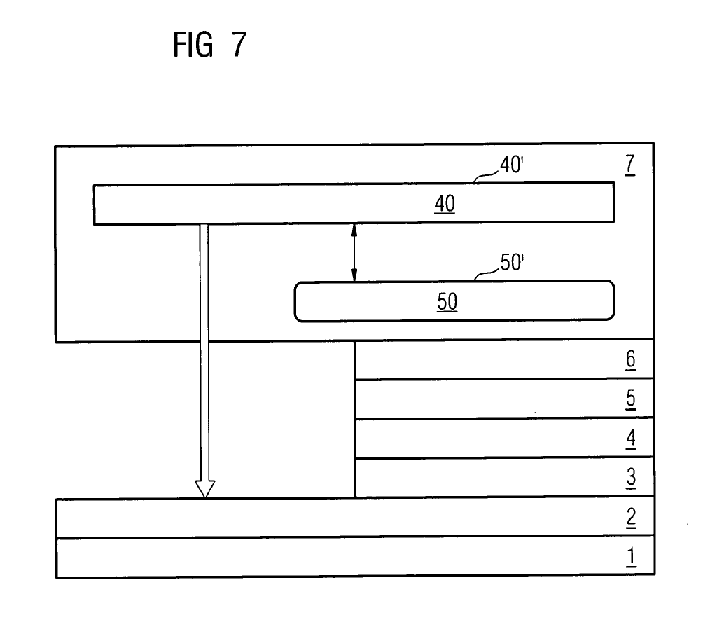

FIG. 7 shows an exemplary embodiment of a substation device with reference to the OSI model.

The preferred embodiments of the present invention will be best understood by reference to the drawings, wherein like parts are designated by like reference signs throughout.

It will be readily understood that the message modification steps of the present invention, as generally described and illustrated in the figures herein, could vary in a wide range of different message modification steps. Thus, the following more detailed description of the exemplary embodiments of the present invention, as represented in FIGS. 1-7 is not intended to limit the scope of the invention, as claimed, but is merely representative of presently preferred embodiments of the invention.

FIG. 1 shows an exemplary embodiment of a substation 10 of an electric power supply system. The substation 10 comprises a plurality of substation devices 20, 21, 22, and 23 which are connected by a communication network 30. The substation devices may be field devices for switching, protecting and/or controlling the electric power supply system.

Each substation device is assigned a device-dependent physical address for communication over the communication network 30. The device-dependent physical addresses of substation devices 20-23 are designated by reference signs PA1-PA4, respectively.

Each substation device is further assigned a device-independent virtual address in addition to the device-dependent physical address. The device-independent virtual addresses of substation devices 20-23 are designated by reference signs VA1-VA4, respectively.

Each substation device comprises an address translating module 40 for translating physical addresses into virtual addresses and vice versa, and a processing module 50 for internally processing the data content of messages.

The internal processing carried out by the processing module 50 is based on the virtual addresses VA1-VA4 of the substation devices 20-23. However, the communication over the communication network 30 is managed based on the device-dependent physical addresses PA1-PA4.

Each address translating module 40 has access to an internal routing table 60 which comprises virtual and physical address pairs, each address pair correlating one of the physical addresses PA1-PA4 to the corresponding virtual address VA1-VA4.

An exemplary embodiment of a routing table 60 is shown in FIG. 2. Each row in routing table 60 comprises an address pair comprising a physical address and the corresponding virtual address.

FIG. 3 shows in an exemplary fashion the transmission of a message M(PA1, PA2) from substation device 20 to substation device 21. The message M(PA1, PA2) indicates the physical address PA1 of the sending substation device 20 and the physical address PA2 of the receiving substation device 21.

Upon receiving the message M(PA1, PA2) the address translating module 40 of substation device 21 replaces the physical addresses PA1 and PA2 contained in the received message M(PA1, PA2) with corresponding virtual addresses VA1 and VA2, and generates a modified message M(VA1, VA2). The exchange of addresses is carried out using the routing table 60 shown in FIG. 2. Then, the modified message M(VA1, VA2) is forwarded to the processing module 50 of substation device 21 and processed therein.

FIG. 4 shows in an exemplary fashion the transmission of a reply message from substation device 21 to substation device 20. First, the processing module 50 of substation device 21 analyzes the received message M(VA1, VA2), processes data and generates an outgoing message based on virtual addresses VA1 and VA2 which are assigned to the substation devices 20 and 21. The generated outgoing message is designated by reference sign M(VA2, VA1) in FIG. 4. Thus, the message M(VA2, VA1) indicates the virtual address VA2 of the sending substation device 21 and the virtual address VA1 of the receiving substation device 20.

The processing module 50 of substation device 21 forwards the outgoing message M(VA2, VA1) to the address translating module 40 of substation device 21. The address translating module 40 modifies the outgoing message M(VA2, VA1) by replacing the virtual addresses VA1 and VA2 with corresponding physical addresses PA1 and PA2. Thus, the address translating module 40 generates a modified outgoing message M(PA2, PA1) which comprises physical addresses, only. Then, the address translating module 40 transmits the modified message M(PA2, PA1) to the recipient, i.e. substation device 20.

FIG. 5 shows in an exemplary fashion the substation 10 of FIG. 1 after replacing the substation device 20 by a new substation device 26. The new substation device 26 comprises a physical address PA6 which differs from the physical address PA1 of old substation device 20.

Upon replacing the substation devices, the new substation device 26—automatically or triggered by personal—publishes an address pair (PA6, VA1) comprising its own physical address PA6 and the virtual address VA1 of the old substation device 20.

The other substation devices 21-23 receive the address pair (PA6, VA1), and update their routing tables 60′. This allows for further communication with new substation device 26 based on physical address PA6. Internal processing of data may be based on virtual address VA1 which was formerly assigned to substation device 20 and which is now assigned to new substation device 26. An exemplary embodiment of an updated routing table 60′ is shown in FIG. 6. Again, each row in the routing table 60′ comprises an address pair comprising a physical address and the corresponding virtual address.

FIG. 7 shows in an exemplary fashion that the address translating module 40 and the processing module 50 may be comprised by an address translating layer 40′ and a processing layer 50′, respectively. Both layers 40′ and 50′ preferably belong to OSI layer 7 (application layer) according to OSI reference model (OSI: Open System Interconnection Reference Model). The address translating layer 40′ has preferably direct access to OSI layer 2 (data link layer) in order to allow for the exchange of physical and virtual addresses contained in messages.

### REFERENCE NUMERALS

10 substation

20-23 substation device

26 new substation device

30 communication network

40 address translating module

40′ address translating layer

50 processing module

50′ processing layer

60 internal routing table

60′ updated internal routing table

M message

PA1-PA6 device-dependent physical address

VA1-VA6 device-independent virtual address

1-12. (canceled)

13. A substation device for a substation of an electric power supply system, the substation device comprising:
a communication unit configured to use device-dependent physical addresses for communication with other substation devices of the substation;
an address translating module for translating the device-dependent physical addresses into device-independent virtual addresses and vice versa; and
a processing module connected to said address translating module, said processing module being configured for processing a data content of messages and for processing the messages based on the virtual addresses.

14. The substation device according to claim 13, wherein said address translating module is configured:
to modify an incoming message to form a modified message by replacing physical addresses comprised therein with corresponding virtual addresses; and
to forward the modified message to said processing module.

15. The substation device according to claim 13, wherein said address translating module is configured:
to modify an outgoing message, which is provided by said processing module, by replacing virtual addresses comprised therein with corresponding physical addresses to form a modified message; and
to transmit the modified message to a given recipient or to multiple recipients.

16. The substation device according to claim 13, wherein said address translating module has access to a routing table comprising virtual and physical address pairs, with each address pair correlating a physical address and a corresponding virtual address.

17. The substation device according to claim 16, which further comprises a memory having the routing table stored therein.

18. The substation device according to claim 17, wherein said address translating module is configured to update the routing table upon receiving an update message comprising an address pair having the physical address of a new device and the virtual address of an old device, which has been replaced by the new device.

19. The substation device according to claim 13, wherein the physical addresses are Media-Access-Control-addresses.

20. A substation of an electric power supply system, the substation comprising:
at least two substation devices each according to claim 13 connected to a communication network;
each of said substation devices having a device-dependent physical address for communication over the communication network and each of said substation devices being assigned a device-independent virtual address in addition to the device-dependent physical address;
each of said substation devices including an address translating module for translating physical addresses into virtual addresses and vice versa; and
each of said substation devices including a processing module for internally processing a data content of messages based on virtual addresses;
said substation devices being connected to said communication network which forwards messages based on physical addresses.

21. A method of operating a substation of an electric power supply system, the method which comprises:
exchanging messages between substation devices via a communication network, the messages indicating a physical address of a respective sender and/or a physical address of a respective recipient;
upon receiving a message, each substation device replacing the physical addresses contained in the received message with corresponding virtual addresses; and
internally processing the received message based on the virtual addresses .

22. The method according to claim 21, which comprises internally processing outgoing messages in the substation devices based on virtual addresses, and replacing all virtual addresses with corresponding physical addresses prior to transmitting the messages via the communication network.

23. The method according to claim 21, which comprises replacing physical addresses with corresponding virtual addresses in the substation devices and vice versa replacing virtual addresses with corresponding physical addresses based on entries in a routing table containing pairs of physical addresses and corresponding virtual addresses.

24. The method according to claim 21, which comprises:
when an old substation device is replaced with a new substation device, publishing with the new substation device an address pair formed with its own physical address and the virtual address of the old substation device;
receiving the address pair with the remaining substation devices, and updating the routing tables thereof in order to send and receive further messages based on the updated routing table with the new address pair.
